(19) United States
(12) Patent Application Publication
(10) Pub. No.: US 2024/0246245 A1
(43) Pub. Date: Jul. 25, 2024

(54) Systems and Methods for Automated Machining a Workpiece

(71) Applicant: The Boeing Company, Arlington, VA (US)

(72) Inventors: Rory Olson, Oregon City, OR (US); Roberto Cantu, Estacada, OR (US); Rebekah Gaddi-Nguyen, Oregon City, OR (US)

(73) Assignee: The Boeing Company, Arlington, VA (US)

(21) Appl. No.: 18/101,196

(22) Filed: Jan. 25, 2023

(51) Int. Cl. B25J 15/04; B25J 11/00; B25J 13/08

(52) U.S. Cl. CPC B25J 15/0491; B25J 11/006; B25J 13/086

(57) ABSTRACT

A machining system includes a robotic manipulator, a master-side automated tool changer, a master-side data transmission connector, and a plurality of end effectors. Each of the end effectors includes a machine tool, a tool-side automated tool changer coupleable to the master-side automated tool changer, and a tool-side data transmission connector coupleable to the master-side data transmission connector. A controller is in communication with the master-side automated tool changer and the master-side data transmission connector. With the master-side automated tool changer coupled to the tool-side automated tool changer of the end effector: power is transferred from the master-side automated tool changer to the tool-side automated tool changer; electrical signals are transferred between the master-side data transmission connector and the tool-side data transmission connector; and the controller identifies the end effector based on one of the electrical signals transferred between the master-side data transmission connector and the tool-side data transmission connector.

### FIELD

The present disclosure relates generally to machining operations and, more particularly, to systems and methods for automated machining a workpiece, such as shaving bushings installed in the workpiece.

### BACKGROUND

During fabrication of a workpiece, a variety of machining operations are often performed. Many of the machining operations have little or no variation between different workpieces. As such, these machining operations can be easily automated by using a single machine tool operating under a single set of processing parameters. Other machining operations often require manual performance because of variations in the types of workpieces, the types of machine tools utilized, and/or the process parameters. However, manual machining operations are often associated with operator safety concerns, ergonomic problems, and/or quality control issues. Accordingly, those skilled in the art continue with research and development efforts in the field of automated machining.

### SUMMARY

Disclosed are examples of a machining system, an end effector, and a machining method. The following is a non-exhaustive list of examples, which may or may not be claimed, of the subject matter according to the present disclosure.

In an example, the disclosed machining system includes a robotic manipulator, a master-side automated tool changer that is coupled to the robotic manipulator, and a master-side data transmission connector that is coupled to the robotic manipulator. The machining system also includes a plurality of end effectors. Each one of the plurality of end effectors includes a machine tool, a tool-side automated tool changer that is coupled to the machine tool and coupleable to the master-side automated tool changer, and a tool-side data transmission connector that is coupled to the machine tool and coupleable to the master-side data transmission connector. The machining system further includes a controller that is in communication with the master-side automated tool changer and the master-side data transmission connector. With the master-side automated tool changer coupled to the tool-side automated tool changer of one of the plurality of end effectors: power is selectively transferred from the master-side automated tool changer to the tool-side automated tool changer; electrical signals are transferred between the master-side data transmission connector and the tool-side data transmission connector; and the controller identifies the one of the plurality of end effectors based on one of the electrical signals transferred between the master-side data transmission connector and the tool-side data transmission connector.

In an example, the disclosed end effector includes a machine tool, a tool-side automated tool changer that is coupled to the machine tool, and a tool-side data transmission connector that is coupled to the machine tool. The tool-side automated tool changer is coupleable to a master-side automated tool changer of a robotic manipulator. The tool-side data transmission connector is coupleable to a master-side data transmission connector of the robotic manipulator. With the master-side automated tool changer coupled to the tool-side automated tool changer of the end effector: power is selectively transferred from the master-side automated tool changer to the tool-side automated tool changer; electrical signals are transferred between the master-side data transmission connector and the tool-side data transmission connector; and the end effector is identifiable based on one of the electrical signals transferred between the master-side data transmission connector and the tool-side data transmission connector.

In an example, the disclosed machining method includes steps of: (1) detecting each one of a plurality of end effectors; (2) retrieving a select one of the plurality of end effectors corresponding to a select one of a plurality of workpiece; (3) identifying the select one of the plurality of end effectors; (4) moving the select one of the plurality of end effectors over a processing location on the select one of the plurality of workpieces; and (5) processing the select one of the plurality of workpiece.

Other examples of the machining system, the end effector, and the machining method disclosed herein will become apparent from the following detailed description, the accompanying drawings, and the appended claims.

### BRIEF DESCRIPTION OF THE DRAWINGS

FIG. 1 is a schematic block diagram of an example of an automated machining system;

FIG. 2 is a schematic illustration of an example of a portion of the automated machining system;

FIG. 3 is a schematic illustration of an example of a portion of a robotic manipulator of the automated machining system;

FIG. 4 is a schematic illustration of an example of an end effector of the automated machining system;

FIG. 5 is schematic illustration of an example of a tooling fixture of the automated machining system;

FIG. 6 is a schematic illustration of an example of the end effector;

FIG. 7 is a schematic illustration of an example of a portion of the end effector;

FIG. 8 is a schematic illustration, in partial cutaway, of an example of a portion of the end effector;

FIG. 9 is a schematic illustration, in partial cutaway, of an example of a portion of the end effector;

FIG. 10 is a schematic illustration of an example of a calibration tool of the automated machining system;

FIG. 11 is a flow diagram of an example of an automated machining method;

FIG. 12 is a schematic illustration of an example of a workpiece and a bushing before an automated machining operation;

FIG. 13 is a schematic illustration of an example of an automated machining operation to shave a portion of the bushing;

FIG. 14 is a schematic illustration of an example of the workpiece and the bushing after the automated machining operation;

FIG. 15 is a flow diagram of an example of an aircraft manufacturing and service method; and

FIG. 16 is a schematic block diagram of an example of an aircraft.

### DETAILED DESCRIPTION

The present disclosure recognizes that many machining operations are still performed manually by a human operator using a machine tool. The human operator is capable of identifying a workpiece from several different types of workpieces, selecting a machine tool that corresponds to the respective workpiece from several different types of machine tools, and implementing appropriate processing parameters. However, manual machining operations can position the operator in awkward body postures or prompt operator fatigue, which can result in a reduction in machining quality. Automated machining operations eliminate many of the problems associated with manual machining. However, automated machining operations are often inflexible to processing variations or are incapable of efficiently and cost-effectively changing between different process parameters. The present disclosure is directed to systems and methods for automated machining that solve these problems.

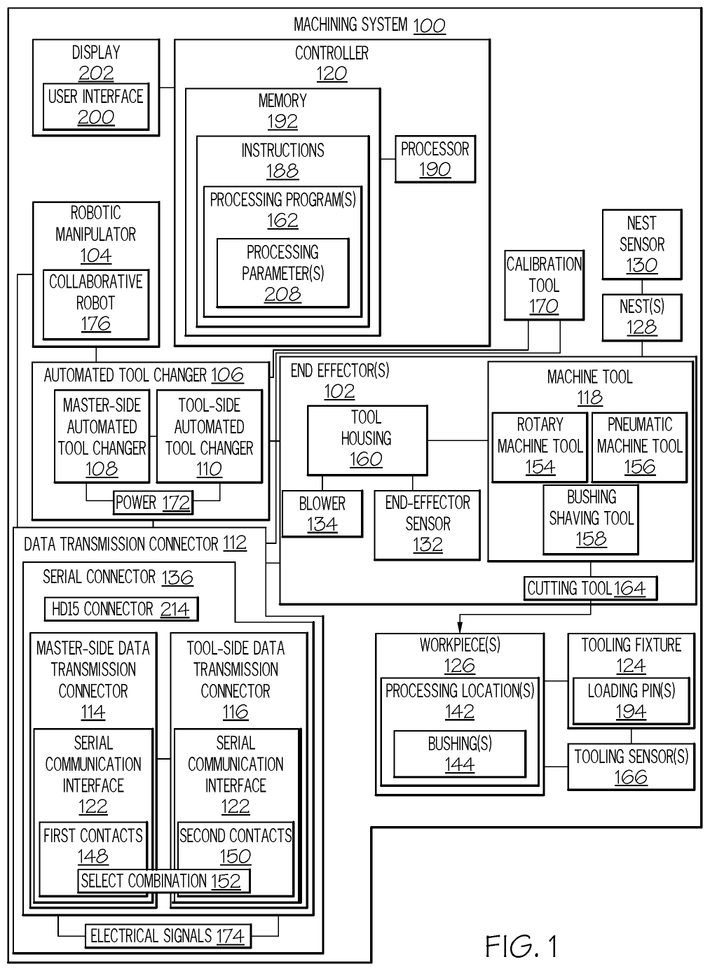

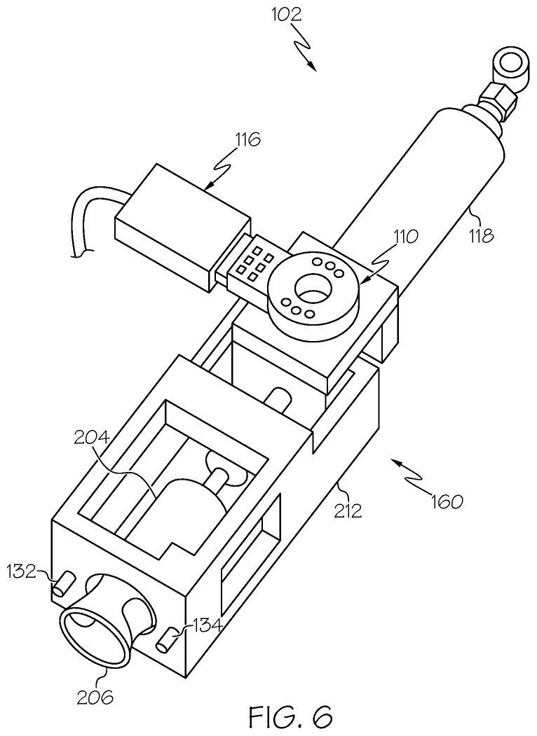

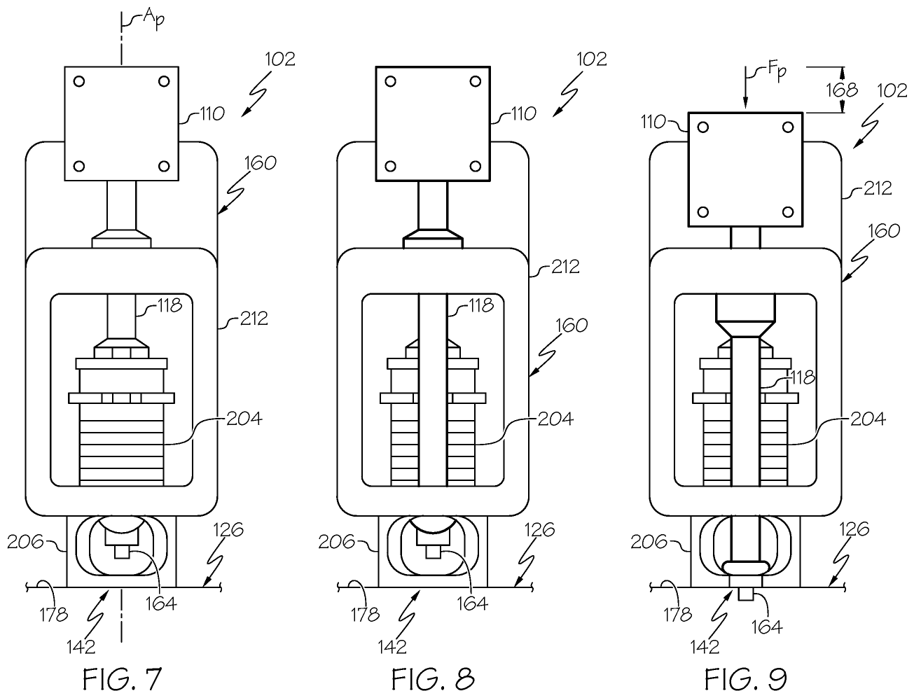

Referring to FIGS. 1-14, by way of examples, the present disclosure is directed to a machining system 100 and a machining method 1000. In one or more examples, the machining system 100 and the machining method 1000 advantageously enable automated detection of a type or kind of workpiece that is to be machined and automated selection of a machine tool and a processing program that corresponds to the workpiece and the machining operation being performed.

Examples of the machining system 100 and the machining method 1000 described herein refer to a machining operation to be performed on (or being performed on) a workpiece 126. The workpiece 126 refers to any one of a plurality of workpieces 126. It can be appreciated that different ones of the workpieces 126 can differ in, among other things, kind, materials, geometries, components, machining operations to be performed, and the like. As such, throughout the present disclosure, such variations may be referred to generally as a “type” of the workpiece 126. General reference to “workpieces” refers to a collection of various types of the workpieces 126 upon which machining operations are to be performed. General reference to “workpiece” refers to one of the plurality of workpieces 126 of a given type that is selected and positioned for performance of the machining operation.

Referring to FIG. 1, in one or more examples, the machining system 100 includes a robotic manipulator 104, a plurality of end effectors 102, and a controller 120. Each one of the end effectors 102 includes a machine tool 118. The machining system 100 also includes an automated tool changer 106. The automated tool changer 106 is utilized for selective mechanical connection of each one of the plurality of end effectors 102 to the robotic manipulator 104. The automated tool changer 106 also enables the transfer of utilities to the machine tool 118 of a connected one of the plurality of end effectors 102. The machining system 100 also includes a data transmission connector 112. The data transmission connector 112 is utilized for electrical communication between the controller 120 and the connected one of the plurality of end effectors 102.

An end of the robotic manipulator 104 is couplable to each one of the plurality of end effectors 102 via the automated tool changer 106. Throughout the present disclosure, the term “coupled one” of the end effectors 102 may be used to refer to any one of the plurality of end effectors 102 that is selected by the machining system 100 and that is coupled to the end of the robotic manipulator 104. General reference to “end effectors” refers to any one of, a combination of, or an entirety of the plurality of end effectors 102. General reference to “end effector” refers to the coupled one of the plurality of end effectors 102. As will become apparent throughout the present disclosure, in one or more examples, each one of the plurality of end effectors 102 corresponds to one type of workpieces 126.

The robotic manipulator 104 moves and/or selectively positions the coupled one of the end effectors 102 in three-dimensional space according to a programmed processing path under direction or command from the controller 120. In one or more examples, the robotic manipulator 104 includes any programmable machine that is capable of automatically performing repetitive tasks under computer control. The robotic manipulator 104 includes various mechanical, electrical, and electronic components. In one or more examples, the robotic manipulator 104 is an articulating robot arm that includes a series of links connected by articulating joints that allow rotational and/or linear motion and that are driven by actuators and/or motors.

In one or more examples, the robotic manipulator 104 includes or takes the form of a collaborative robot 176. The collaborative robot 176, also referred to as a “cobot,” is a robot intended for direct human-robot interaction within a shared space or for where humans and robots are in close proximity. The collaborative robot 176 includes a variety of safety mechanisms that rely on lightweight construction materials, rounded edges, inherent limitations of speed and/or force, and/or sensors and software that ensure safe behavior.

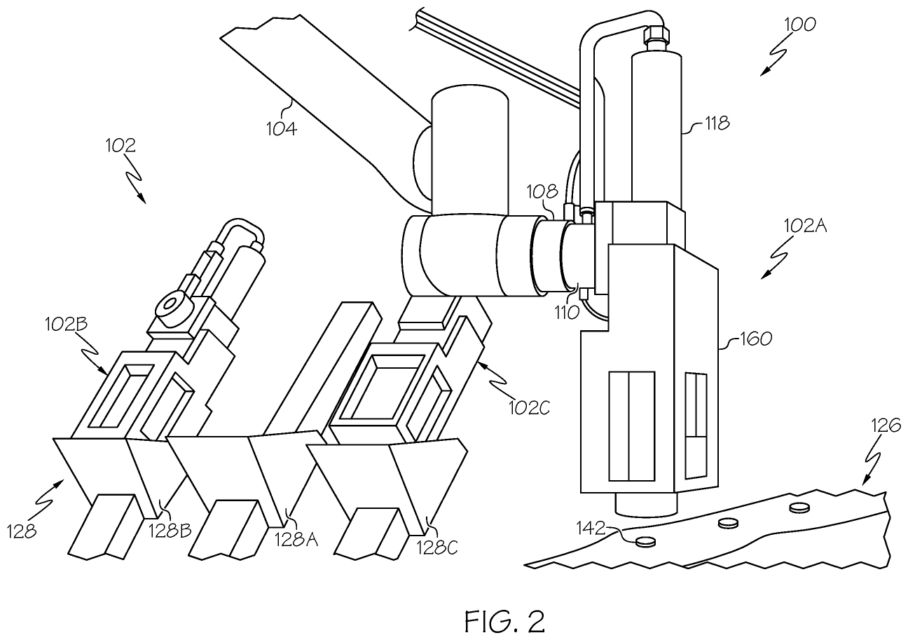

Each one of the plurality of end effectors 102 is selectively connectable to the end of the robotic manipulator 104 (e.g., as shown in FIG. 2). Each one of the plurality of end effectors 102 interacts with the manufacturing environment. For example, each one of the end effectors 102 includes the machine tool 118. The machine tool 118 is configured to otherwise adapted to perform at least one manufacturing operation on the workpiece 126. Generally, the machine tool 118 is any mechanism that interacts with or performs an operation on the workpiece. As examples, the machine tool 118 includes or takes the form of a cutting tool, a boring tool, a shaving tool, a grinding tool, a shearing tool, a sanding tool, or other subtractive manufacturing tool. As other examples, the machine tool 118 includes or takes the form on a gripper tool. As yet other examples, the machine tool 118 includes or takes the form of a fastener installation tool, a welding tool, a composite placement tool, a coating tool, or any other suitable manufacturing tool.

In one or more examples, the machine tool 118 includes a rotary machine tool 154. In one or more examples, the machine tool 118 includes a pneumatic machine tool 156. In one or more examples, the machine tool 118 includes a bushing shaving tool 158. In one or more examples, the bushing shaving tool 158 is a pneumatic shaver and cutter commercially available from Zephyr® Tool Group of California, USA.

FIG. 2 illustrates an example of a portion of a manufacturing environment within which the machining system 100 operates. The example shown in FIG. 2 illustrates three of the end effectors 102, identified individually as a first end effector 102A (e.g., a first one of the plurality of end effectors 102), a second end effector 102B (e.g., a second one of the plurality of end effectors 102), and a third end effector 102C (e.g., a third one of the plurality of end effectors 102). In the example illustrated in FIG. 2, the first end effector 102A is the coupled one of the end effectors 102, which is coupled to the robotic manipulator 104 and is positioned by the robotic manipulator 104 relative to a processing location 142 on the workpiece 126. In other examples, less than three or more than three of the end effectors 102 may be utilized with the machining system 100.

Referring to FIGS. 1 and 2, in one or more examples, each one of the plurality of end effectors 102 is different from another one of the plurality of end effectors 102 in some manner. For example, each one of the plurality of end effectors 102 is configured to perform a different (e.g., particular) type of machining operation or is configured to perform a machining operation on a different (e.g., particular) type of the workpieces 126. As an example, the machine tool 118 of each one of the end effectors 102 is different. As another example, each one of the plurality of end effectors 102 is configured to perform a machining operation under different ones of the processing parameters 208 (FIG. 1). As other examples, dimensions of a cutting tool 164 used by the machine tool 118 of each of the end effectors 102 are different, the operating speed of the machine tool 118 of each one of the end effectors 102 is different, the stroke length of the machine tool 118 of each one of the end effectors 102 is different, and the like. As yet another example, each one of the plurality of end effectors 102 is configured to perform an operation on a one type of a plurality of different types of workpieces 126.

Referring again to FIG. 1, in one or more examples, the automated tool changer 106 provides flexibility to automatically change different ones of the end effectors 102. The automated tool changer 106 is designed to function reliably at rated loads while maintaining extremely high repeatability. The automated tool changer 106 includes two mating parts, a master-side automated tool changer 108 and a tool-side automated tool changer 110. The master-side automated tool changer 108 and the tool-side automated tool changer 110 are designed to lock or couple together automatically, carry a payload, and have the ability to pass utilities, such as power 172.

In one or more examples, the data transmission connector 112 provides flexibility to automatically connect communications with different ones of the end effectors 102 when interchanged. The data transmission connector 112 is designed to function reliably at rated loads while maintaining extremely high repeatability. The data transmission connector 112 includes two mating parts, a master-side data transmission connector 114 and a tool-side data transmission connector 116. The master-side data transmission connector 114 and the tool-side data transmission connector 116 are designed to mate together automatically and have the ability to pass electrical signals 174.

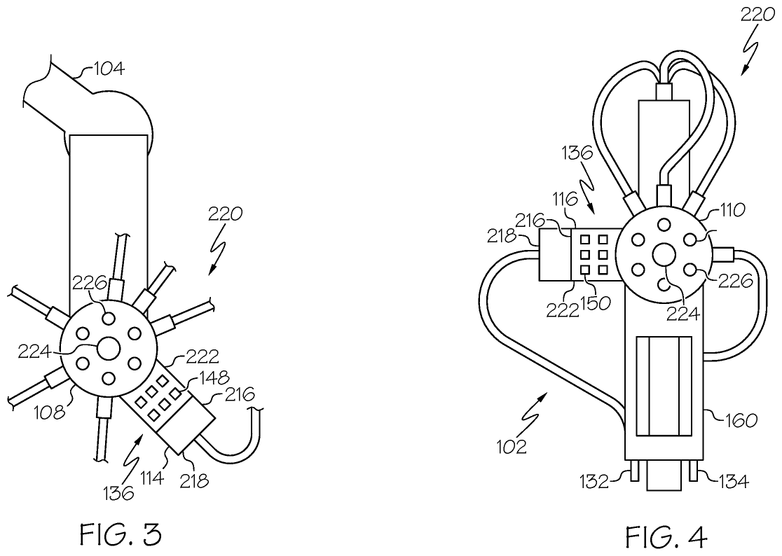

Referring to FIGS. 3 and 4, in one or more examples, the master-side automated tool changer 108 is coupled to the robotic manipulator 104. Each one of the end effectors 102 includes the tool-side automated tool changer 110. In one or more examples, the tool-side automated tool changer 110 is coupled to the machine tool 118. The tool-side automated tool changer 110 is coupleable to the master-side automated tool changer 108.

In one or more examples, the master-side data transmission connector 114 is coupled to the robotic manipulator 104. In one or more examples, the master-side data transmission connector 114 is coupled to or is integrated with the master-side automated tool changer 108. Each one of the end effectors 102 includes the tool-side data transmission connector 116. In one or more examples, the tool-side data transmission connector 116 is coupled to the machine tool 118. In one or more examples, the tool-side data transmission connector 116 is coupled to or is integrated with the tool-side automated tool changer 110. The tool-side data transmission connector 116 is coupleable to the master-side data transmission connector 114.

Referring again to FIG. 1, in one or more examples, the controller 120 is coupled to and is in communication with the master-side automated tool changer 108 and the master-side data transmission connector 114. The controller 120 is in selective communication with the tool-side data transmission connector 116 of the coupled one of the end effectors 102 via connection between the master-side data transmission connector 114 and the tool-side data transmission connector 116.

With the master-side automated tool changer 108 coupled to the tool-side automated tool changer 110 of the coupled one of the end effectors 102, power 172 is selectively transferred from the master-side automated tool changer 108 to the tool-side automated tool changer 110. The machine tool 118 is coupled to and is in communication with the tool-side automated tool changer 110. The power 172 is transferred from the tool-side automated tool changer 110 to the machine tool 118. For the purpose of the present disclosure, “power” refers to any utility required to energize or operate the machine tool 118 including, but not limited to, electrical power, pneumatic power, hydraulic power, and the like.

With the master-side automated tool changer 108 coupled to the tool-side automated tool changer 110 of the coupled one of the end effectors 102, electrical signals 174 are transferred between the master-side data transmission connector 114 and the tool-side data transmission connector 116. As will be described in greater detail herein, the electrical signals 174 are used by the controller 120 to identify the coupled one of the end effectors 102. As an example, with the master-side automated tool changer 108 coupled to the tool-side automated tool changer 110 of the coupled one of the end effectors 102, the controller 120 identifies the coupled one of the plurality of end effectors 102 based on one of the electrical signals 174 transferred between the master-side data transmission connector 114 and the tool-side data transmission connector 116. Additionally, the electrical signals 174 may include sensor data or other information transmitted between the coupled one of the end effector 102 and the controller 120.

Referring to FIG. 1, in one or more examples, in one or more examples, the data transmission connector 112 includes a serial connector 136. In these examples, the master-side data transmission connector 114 and the tool-side data transmission connector 116 of each one of the end effectors 102 includes a serial communication interface 122. In one or more examples, the data transmission connector 112, including the master-side data transmission connector 114 and the tool-side data transmission connector 116, of each one of the plurality of end effectors 102 includes or takes the form of an HD15 type connector 214.

Referring to FIGS. 1, 3 and 4, in one or more examples, the master-side data transmission connector 114 (e.g., the serial connector 136) includes a contact pad 222 having a plurality of first contacts 148. The tool-side data transmission connector 116 (e.g., serial connector 136) of each one of the plurality of end effectors 102 includes the contact pad 222 having a plurality of second contacts 150. With the master-side automated tool changer 108 coupled to the tool-side automated tool changer 110 of the coupled one of the plurality of end effectors 102, a select combination 152 of the second contacts 150 and the first contacts 148 complete an electrical circuit between the master-side data transmission connector 114 and the tool-side data transmission connector 116 that corresponds to the coupled one of the plurality of end effectors 102.

In one or more examples, the serial connector 136 of the master-side data transmission connector 114 and the tool-side data transmission connector 116 also includes a serial port 216 and a serial plug 218 that is connected to the serial port 216. Each one of the plurality of first contacts 148 corresponds to one of the pins of the serial connector 136 of the master-side data transmission connector 114. Each one of the plurality of second contacts 150 corresponds to one of the pins of the serial connector 136 of the tool-side data transmission connector 116. When the first contacts 148 of the contact pad 222 of the master-side data transmission connector 114 and the second contacts 150 of the contact pad 222 of the tool-side data transmission connector 116 make intimate contact, energized ones of the first contacts 148 and ones of the second contacts 150 corresponding to active pins of serial connector 136 and form the select combination 152, which completes the electrical circuit. Based on the completed electrical circuit and the electrical signal 174 transferred between the controller 120 and the tool-side data transmission connector 116, the controller 120 can identify which one of the end effectors 102 is coupled to the robotic manipulator 104.

In one or more examples, the automated tool changer 106 includes one or more utility lines 220 that transfer utilities, such as power 172, to the master-side automated tool changer 108 and from the tool-side automated tool changer 110 to the machine tool 118. The automated tool changer 106 also includes one or more utility ports 226 that enable the transfer of utilities, such as power 172, from the master-side automated tool changer 108 to the tool-side automated tool changer 110. The automated tool changer 106 also includes a lock 224 that enables secure and selectively activated and deactivated mechanical connection between the master-side automated tool changer 108 and the tool-side automated tool changer 110. In one or more examples, the automated tool changer 106 also includes a lock sensor. The lock sensor is configured to detect whether the lock 224 is completely engaged. In one or more examples, the lock sensor provides two signals representing the status of the lock 224, namely locked and unlocked. In one or more examples, the automated tool changer 106 and the data transmission connector 112 are integrated into a tool changer unit, which is commercially available from ATI Industrial Automation, Inc. of North Carolina, USA.

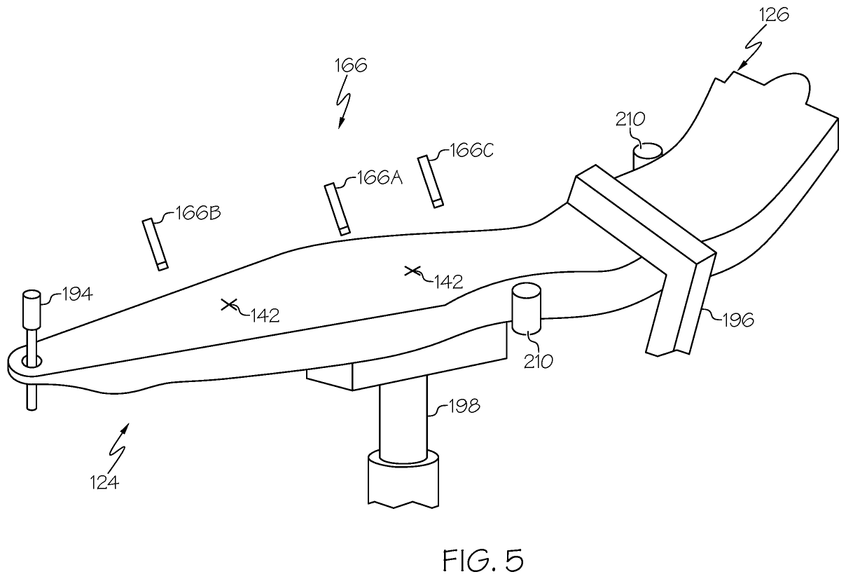

Referring to FIGS. 1 and 5, in one or more examples, the machining system 100 includes a tooling fixture 124. The tooling fixture 124 supports each one of the plurality of workpieces 126. For example, the workpiece 126 of any type is loaded and secured in the tooling fixture 124 in a correct position for machining. In one or more examples, the tooling fixture 124 includes a lift 198. The lift 198 supports the workpiece 126 and moves the workpiece 126 into a correct position for machining. In one or more examples, the tooling fixture 124 includes a clamp 196. The clamp 196 secures the workpiece 126 in the correct position for machining. In one or more examples, the tooling fixture 124 includes one or more indexing pins 210. In one or more examples, the machining system 100 includes a plurality of loading pins 194. Each one of the loading pins 194 corresponds to one of the types of the workpieces 126.

In one or more examples, the workpiece 126 is loaded in the tooling fixture 124 using the loading pin 194 corresponding to the workpiece 126, for example, at an end of the workpiece 126 (e.g., as shown in FIG. 5). The workpiece 126 is then lifted into a proper processing position using the lift 198. In one or more examples, the workpiece 126 is pressed against one or more of the indexing pins 210 to ensure the workpiece 126 is in a correct position. In one or more examples, the workpiece 126 is secured to the tooling fixture 124 and clamped at the processing position using the clamp 196.

In one or more examples, the machining system 100 includes a tooling sensor 166. The tooling sensor 166 identifies each one of the plurality of workpieces 126 supported by the tooling fixture 124. As an example, the tooling sensor 166 detects the workpiece 126 and identifies or determines the type of the workpiece 126 (e.g., which type from the various different types of the workpieces 126).

In one or more examples, the machining system 100 includes a plurality of tooling sensors 166. In the example illustrated in FIG. 5, the machining system 100 utilizes three of the tooling sensors 166, identified individually as a first tooling sensor 166A (e.g., a first one of the plurality of tooling sensors 166), a second tooling sensor 166B (e.g., a second one of the plurality of tooling sensors 166), and a third tooling sensor 166C (e.g., a third one of the plurality of tooling sensors 166). In one or more examples, the tooling sensors 166 are integrated into or form a portion of the tooling fixture 124. In these examples, each one of the tooling sensors 166 corresponds to one of the types of the workpieces 126.

In one or more examples, the controller 120 is configured to identify the type of the workpiece 126 loaded in the tooling fixture 124 based on a signal from the tooling sensors 166. The tooling sensors 166 are configured to detect the type of the workpiece 126 loaded in the tooling fixture 124. In one or more examples, the tooling sensors 166 are proximity sensors configured to detect a physical feature or a structural component of the workpiece 126 when the workpiece 126 is loaded in the correct processing position. In other examples, the tooling sensors 166 can be any other suitable type of sensors configured to identify the workpiece 126, such as, but not limited to, radio frequency identification (RFID), laser scanners, cameras, and the like.

Generally, identification of the workpiece 126 loaded in and supported by the tooling fixture 124 is used to automatically select one of the end effectors 102 and one of a plurality of processing programs 162 that correspond to the workpiece 126. In one more examples, the controller 120 selects one of the plurality of end effectors 102 for a corresponding one of the plurality of workpieces 126. As an example, upon identification of the workpiece 126 (e.g., determination of the type of the workpiece 126), the controller 120 determines which one of the end effectors 102 corresponds to the workpiece 126 and instructs the robotic manipulator 104 to retrieve the selected one of the end effectors 102. The controller 120 also determines which one of the processing programs 162 corresponds to the workpiece 126 and instructs the robotic manipulator 104 and the machine tool 118 according to the selected one of the processing programs 162.

Referring FIGS. 1 and. 2, in one or more examples, the machining system 100 includes a plurality of nests 128. Each one of the plurality of nests 128 supports a corresponding one of the plurality of end effectors 102. In one or more examples, the machining system 100 also includes a plurality of nest sensors 130 (FIG. 1). Each one of the nest sensors 130 is associated with one of the nests 128 and detects that one of the plurality of end effectors 102 is supported by a corresponding one of the nests 128. The example shown in FIG. 2 illustrates three of the nests 128, identified individually as a first nest 128A (e.g., a first one of the plurality of nests 128), a second nest 128B (e.g., a second one of the plurality of nests 128), and a third nest 128C (e.g., a third one of the plurality of nests 128). In the example illustrated in FIG. 2, the first end effector 102A is removed from the first nest 128A. In other examples, less than three or more than three of the nests 128 may be utilized with the machining system 100. Generally, the number of nests 128 corresponds to the number of end effectors 102.

Referring to FIGS. 1, 4 and 6, in one or more example, each one of the end effectors 102 includes an end-effector sensor 132. The end-effector sensor 132 detects proximity to the workpiece 126. In one or more examples, the end-effector sensor 132 is a proximity sensor, such as a non-contact proximity sensor. The end-effector sensor 132 is coupled to and is in electrical communication with the tool-side data transmission connector 116. With the end effector 102 coupled to the robotic manipulator 104 and the tool-side data transmission connector 116 coupled to the master-side data transmission connector 114, the end-effector sensor 132 is in communication with the controller 120. In one or more examples, the end-effector sensor 132 detects the workpiece surface 178 when the robotic manipulator 104 positions the end effector 102 over the processing location 142 for machining the workpiece 126.

Referring to FIGS. 1, 4 and 6, each one of the end effectors 102 includes a blower 134. The blower 134 directs a flow of compressed air. In one or more examples, the blower 134 is connected to and is in fluid communication with the tool-side automated tool changer 110. With the end effector 102 coupled to the robotic manipulator 104 and the tool-side automated tool changer 110 coupled to the master-side automated tool changer 108, the blower 134 is in fluid communication a compressed air source (e.g., a utility). In one or more examples, the blower 134 directs the compressed air to the workpiece surface 178 around the processing location 142, before and/or after the machining operation, to remove debris and other foreign objects.

Referring to FIGS. 1, 3 and 4, in one or more examples, each one of the plurality of end effectors 102 routes a lubricant to the machine tool 118. In one or more examples, the lubricant is transferred to the machine tool 118 through the automated tool changer 106.

Referring to FIGS. 1 and 6-9, in one or more examples, each one of the plurality of end effectors 102 includes a tool housing 160. The machine tool 118 is coupled to the tool housing 160. The machine tool 118 is movable relative to the tool housing 160 along a processing axis Ap. In one or more examples, the tool housing 160 includes a cage 212. The cage 212 surrounds at least a portion of the machine tool 118, such as a motor and/or transmission of the machine tool 118. The tool housing 160 also includes a sleeve 204. The sleeve 204 is coupled to the cage 212 and is fixed relative to the cage 212. The sleeve 204 surrounds a portion of the machine tool 118, such as a spindle, a tool holder, and the cutting tool 164. In one or more examples, the machine tool 118 is movable along the processing axis Ap relative to the cage 212 and the sleeve 204. During the machining operation, the robotic manipulator 104 positions the end effector 102 over the processing location 142 such that the sleeve 204 is in contact with the workpiece surface 178. The robotic manipulator 104 applies a processing force Fp to the machine tool 118 via connection of the automated tool changer 106 to move the machine tool 118 along the processing axis Ap relative to the cage 212 and the sleeve 204. In one or more examples, the cage 212 guides motion of the machine tool 118 along the processing axis Ap and supports the machine tool 118. The sleeve 204 provides a motion limit for the machine tool 118. In one or more examples, the sleeve 204 includes a guard 206 that surrounds the cutting tool 164.

As illustrated in FIG. 9, in one or more examples, a stroke tool 168 of the machine tool 118 along the processing axis Ap and relative to the tool housing 160 is selectively adjustable. In one or more examples, the tool stroke 168 is one of the processing parameters 208 of the processing program 162 that corresponds to the workpiece 126 and is modifiable by a human operator using a user interface 200 of the machining system 100. In one or more examples, the tool stroke 168 is physically adjusted (e.g., a maximum and/or minimum limit can be set) by adjusting a location of the sleeve 204 along the processing axis Ap relative to the cage 212 of the tool housing 160.

In one or more examples, there are three of the end effectors 102 and three of the nests 128. Each one of the end effectors 102 is loaded in and is supported by a corresponding one of the nests 128. Each one of the end effectors 102 supports the machine tool 118, the tool-side automated tool changer 110, the tool-side data transmission connector 116, the blower 134, and the end-effector sensor 132. Each one of the nests 128 locates a corresponding one of the end effectors 102 to specific coordinates so the robotic manipulator 104 can move into proper position to retrieve one of the end effectors 102. Each one of the nests 128 also includes the nest sensor 130 that detects whether the corresponding one of the end effectors 102 is loaded and ready to be used for a corresponding machining operation based on one of the processing programs 162. In one or more examples, each one of the end effectors 102 is color coded to show that is associated with a particular machining operation or one of the workpieces 126. The colors are shown on user interface 200 of a display 202 of the machining system 100.

The master-side automated tool changer 108 is connected to the end of the robotic manipulator 104 and is used to pickup and hold the end effector 102 via the tool-side automated tool changer 110. In one or more examples, the automated tool changer 106 includes a pneumatic actuator that is used to engage the master-side automated tool changer 108 to the tool-side automated tool changer 110. In one or more examples, the automated tool changer 106 includes a plurality of air fittings, lock sensor, data transmission connector, an oil supply, and the like.

With the end effector 102 connected to the robotic manipulator 104 by the automated tool changer 106, the data transmission connector 112 is used to send a signal to the controller 120 to indicate which one of the end effectors 102 is connected to the robotic manipulator 104. Detection and identification of the end effector 102 eliminate risk of having the machining system 100 use an incorrect one of the end effectors 102 (e.g., an incorrect type of machine tool 118) on a particular type of the workpiece 126. The automated tool changer 106 also enables transmission of a signal from the end-effector sensor 132 to the controller 120.

During the machining operation, the robotic manipulator 104 applies pressure (e.g., a downward processing force Fp) to the machine tool 118 to engage the cutting tool 164 of machine tool 118 with the processing location 142 on the workpiece 126. The tool housing 160 of the end effector 102 enables the machine tool 118 to remain stable while enabling the machine tool 118 to move along the processing axis Ap.

The end-effector sensor 132 detects if the workpiece 126 is properly loaded in the tooling fixture 124 in a correct position. In one or more examples, the machine tool 118 will not energize until the end-effector sensor 132 detects the workpiece 126 and transmits a signal to the controller 120.

In one or more examples, the tool housing 160 also includes the guard 206. The guard 206 prevents access to the cutting tool 164 of the machine tool 118 during the machining operation, thereby providing a safety feature for the operator.

The blower 134 directs compressed air toward the workpiece surface 178. Compressed air is directed at the workpiece surface 178 before and/or after the machining operations. The blowing operation ensures that any debris (e.g., metal chips) is cleared away before the machining system 100 performs the machining operation.

The processing program 162 includes a number of processing parameters 208. Examples of the processing parameters 208 include start offset distance, machining speed (e.g., feed rate, rotational speed, etc.), dwell time, and the like. The processing parameters 208 are modifiable by the operator, for example, using the user interface 200. The processing parameters 208 are associated with the workpiece 126 to be machined and/or the machining operation being performed.

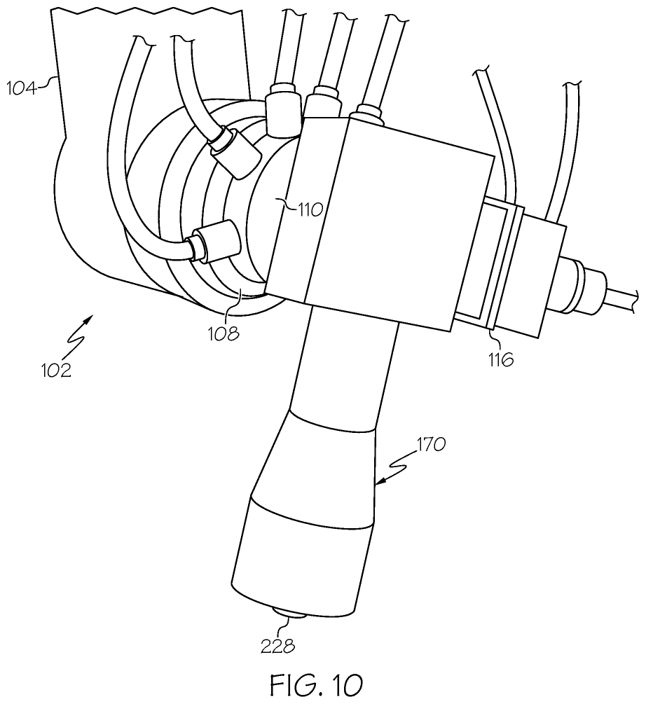

Referring to FIGS. 1 and 10, in one or more examples, the machining system 100 includes a calibration tool 170. The calibration tool 170 is used during a calibration sequence that enables the robotic manipulator 104 to align with the processing location 142 on the workpiece 126. In one or more examples, the calibration tool 170 includes the tool-side automated tool changer 110 that enables connection of the calibration tool 170 to the robotic manipulator 104. When coupled to the robotic manipulator 104, the calibration tool 170 mimics the end effector 102. During a calibration sequence, an operator manually positions a protrusion 228 projecting from an end of the calibration tool 170 in contact with the processing location 142 on the workpiece 126. When the protrusion 228 in contact with the processing location 142, the controller 120 can be set with the coordinates of the processing location 142.

In one or more examples, the calibration tool 170 includes the tool-side automated tool changer 110. In one or more examples, the tool-side automated tool changer 110 is coupled to a body of the calibration tool 170. The tool-side automated tool changer 110 is coupleable to the master-side automated tool changer 108 to couple the calibration tool 170 to the end of the robotic manipulator 104.

In one or more examples, the calibration tool 170 also includes the tool-side data transmission connector 116. In one or more examples, the tool-side data transmission connector 116 is coupled to the body of the calibration tool 170. In one or more examples, the tool-side data transmission connector 116 is coupled to or is integrated with the tool-side automated tool changer 110. The tool-side data transmission connector 116 is coupleable to the master-side data transmission connector 114. In one or more examples, the calibration tool 170 includes the serial connector 136 and is configured to engage the master-side data transmission connector 114 as described herein. In one or more examples, the controller 120 is in selective communication with the tool-side data transmission connector 116 of the calibration tool 170 via connection between the master-side data transmission connector 114 and the tool-side data transmission connector 116. With the master-side automated tool changer 108 coupled to the tool-side automated tool changer 110 of the calibration tool 170, electrical signals 174 are transferred between the master-side data transmission connector 114 and the tool-side data transmission connector 116. As described herein above with respect to the end effectors 102, the electrical signals 174 are used by the controller 120 to identify the calibration tool 170. As an example, with the master-side automated tool changer 108 coupled to the tool-side automated tool changer 110 of the calibration tool 170, the controller 120 identifies the calibration tool 170 based on one of the electrical signals 174 transferred between the master-side data transmission connector 114 and the tool-side data transmission connector 116. In one or more examples, the calibration tool 170 has its own code so the machining system 100 knows the calibration tool 170 is loaded. In one or more examples, identification of the calibration tool 170 is used to automatically select one of a plurality of processing programs 162 that correspond to the calibration tool 170.

Referring to FIGS. 1-4 and 6-9, by way of examples, the present disclosure is also directed to the end effector 102. As described herein and illustrated in FIGS. 1-4 and 6-9, in one or more examples the end effector 102 includes the machine tool 118, the tool-side automated tool changer 110 that is coupled to the machine tool 118, and the tool-side data transmission connector 116 that is coupled to the machine tool 118. The tool-side automated tool changer 110 is coupleable to the master-side automated tool changer 108 of the robotic manipulator 104. The tool-side data transmission connector 116 is coupleable to the master-side data transmission connector 114 of the robotic manipulator 104. With the master-side automated tool changer 108 coupled to the tool-side automated tool changer 110 of the end effector 102, power 172 is selectively transferred from the master-side automated tool changer 108 to the tool-side automated tool changer 110. With the master-side automated tool changer 108 coupled to the tool-side automated tool changer 110 of the end effector 102, electrical signals 174 are transferred between the master-side data transmission connector 114 and the tool-side data transmission connector 116. With the master-side automated tool changer 108 coupled to the tool-side automated tool changer 110 of the end effector 102, the end effector 102 is identifiable based on one of the electrical signals 174 transferred between the master-side data transmission connector 114 and the tool-side data transmission connector 116.

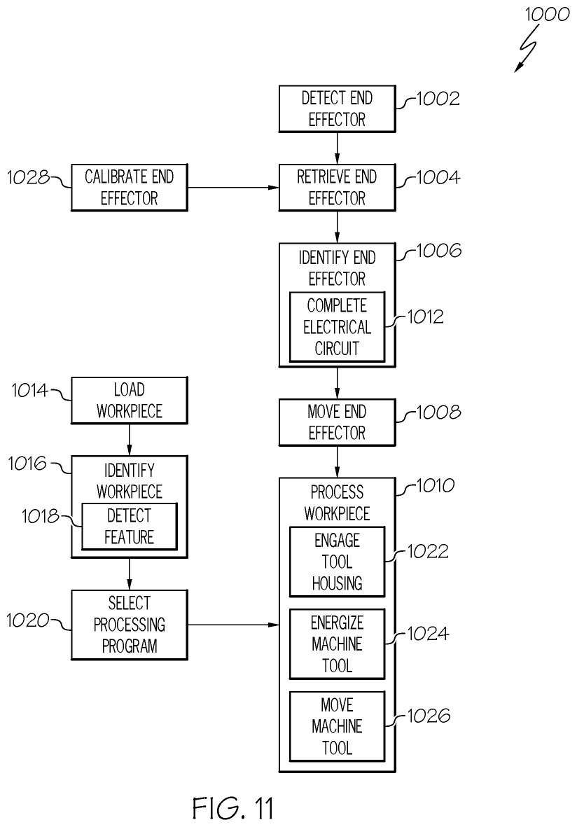

FIG. 11 illustrates an example of the machining method 1000. In one or more examples, implementation of the machining method 1000 is performed using the machining system 100 or the end effector 102. In one or more examples, the machining method 1000 is a computer-implemented method. As an example, the operational steps describing the machining method 1000 are performed by the controller 120 programmed with and executing the instructions

Referring particularly to FIG. 11, as well as to FIGS. 1-10, in one or more examples, the method 1000 includes a step of (block 1002) detecting each one of the plurality of end effectors 102. In one or more examples, the end effectors 102 are detected while in the nests 128 by the nest sensors 130.

In one or more examples, the method 1000 includes a step of (block 1004) retrieving a select one of the plurality of end effectors 102 corresponding to a select one of the plurality of workpiece 126. One of the end effectors 102 is selected by the controller 120 and is retrieved by the robotic manipulator 104 under direction of the controller 120. Mechanical connection of the end effector 102 is achieved by the automated tool changer 106. Electrical connection of the end effector 102 is achieved by data transmission connector 112.

In one or more examples, the method 1000 includes a step of (block 1006) identifying the select one of the plurality of end effectors 102. Identification of the selected and coupled one of the end effectors 102 is achieved by the controller 120 based on the select combination 152 of the first contacts 148 of the master-side data transmission connector 114 and the second contacts 150 of the tool-side data transmission connector 116, which complete an electrical circuit that corresponds to that end effector 102.

In one or more examples, the method 1000 includes a step of (block 1008) moving the select one of the plurality of end effectors 102 over the processing location 142 on the select one of the plurality of workpieces 126. The end effector 102 is positioned over the processing location 142 by the robotic manipulator 104 under direction of the controller 120. Motion of the robotic manipulator 104 is commanded according to the processing program 162 that is selected by the controller 120 based on the type of the workpiece 126.

In one or more examples, the method 1000 includes a step of (block 1010) processing the select one of the plurality of workpiece 126. Any suitable processing or machining operation can be performed on the workpiece 126 by the machine tool 118.

In one or more examples, according to the method 1000, the step of (block 1006) identifying the select one of the plurality of end effectors 102 includes a step of (block 1012) completed an electrical circuit between the select combination 152 of the plurality of second contacts 150 of the tool-side data transmission connector 116 and the plurality of first contacts 148 of the master-side data transmission connector 114.

In one or more examples, the method 1000 includes a step of (block 1014) loading the select one of the plurality of workpieces 126 into the tooling fixture 124. The method 1000 includes a step of (block 1016) identifying the select one of the plurality of workpieces 126. Identification of the workpiece 126 (e.g., determination of the type of the workpiece 126) is performed by the controller 120 based on the signal provided by the tooling sensor 166. In one or more examples, according to the method 1000, the step of (block 1016) identifying the select one of the plurality of workpieces 126 includes a step of (block 1018) detecting a feature of the select one of the plurality of workpieces 126.

In one or more examples, the method 1000 includes a step of (block 1020) selecting one of a plurality of processing programs 162 based on identification of the select one of the plurality of workpieces 126.

In one or more examples, according to the method 1000, the step of (block 1010) processing the select one of the plurality of workpiece 126 includes a step of (block 1022) engaging the tool housing 160 of the select one of the plurality of end effectors 102 with the select one of the plurality of workpieces 126, a step of (block 1024) energizing the machine tool 118 of the select one of the plurality of end effectors 102, and a step of (block 1026) moving the machine tool 118 relative to the tool housing 160 along the processing axis Ap.

In one or more examples, the method 1000 includes a step of (block 1028) calibrating movement of the select one of the end effectors 102 relative to the processing location 142 on the select one of the plurality of workpieces 126. Calibration of the robotic manipulator 104 is performed using the calibration tool 170.

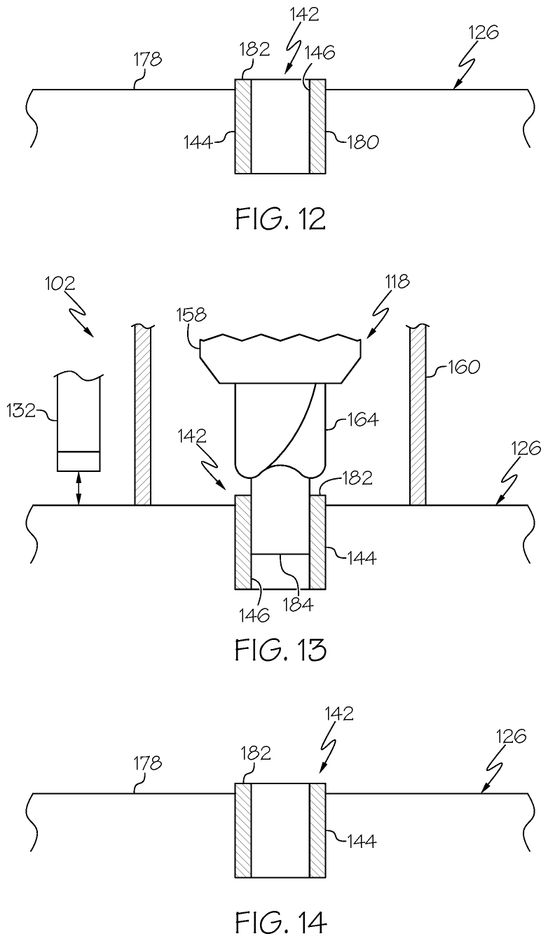

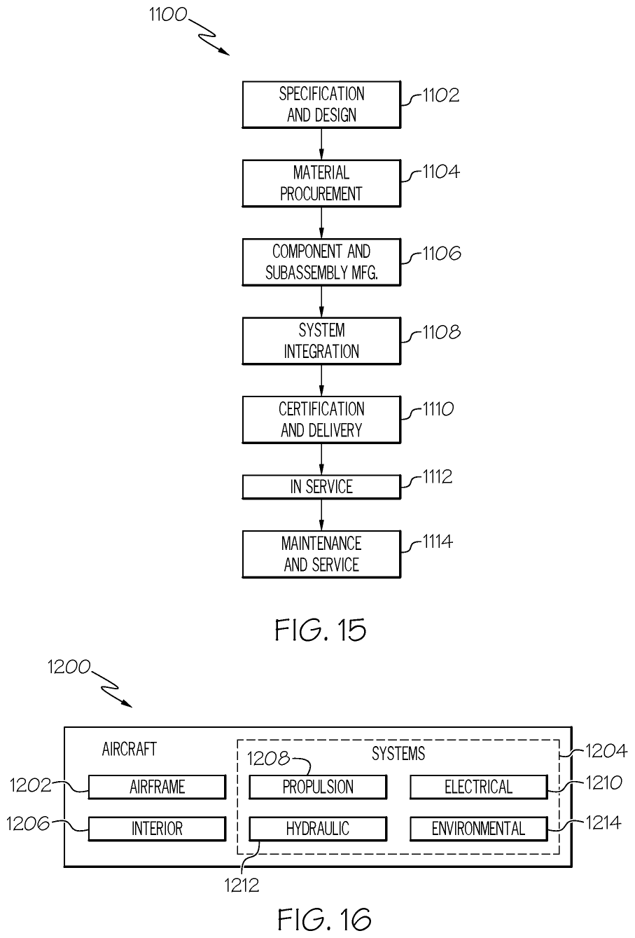

Referring now to FIGS. 12-14, in one or more examples, the machining system 100 is exemplified as a performing a bushing shaving operation on the workpiece 126. In these examples, the machine tool 118 includes the bushing shaving tool 158 that rotates the cutting tool 164 to trim or shave a bushing 144. In one or more examples, each one of the plurality of workpieces 126 includes at least one bushing 144. The bushing 144 is located (e.g., is previously inserted) in a hole 180 formed at least partially through the workpiece 126. An end portion 182 of the bushing 144 extends from the hole 180 and protrudes beyond a workpiece surface 178. The present disclosure recognizes that in certain applications, it is desirable for the end portion 182 of the bushing 144 to be at least approximately flush with the workpiece surface 178. In these examples, the bushing 144 represents the processing location 142 on the workpiece 126. The end effector 102 is positioned over the bushing 144. In one or more examples, the machine tool 118 includes a probe 184 that is configured to be inserted into a bushing opening 146 of the bushing 144 during the shaving operation. Insertion of the probe 184 into the bushing 144 ensures that the machine tool 118 is properly aligned. In one or more examples, the probe 184 forms a portion of the cutting tool 164 and/or extends from an end of the cutting tool 164. The bushing shaving tool 158 is moved toward the bushing 144 by the robotic manipulator 104 such that the cutting tool 164 shaves off a portion of the bushing 144 and the end portion 182 of the bushing 144 is at least approximately flush with the workpiece surface 178, as shown in FIG. 14.

In an exemplary implementation of a machining operation performed on the workpiece 126 by the machining system 100 and/or according to the machining method 1000, a human operator selects one of the loading pins 194 based on and corresponding to the type of the workpieces 126 to be machined. Initially, the controller 120 detects which of the end effectors 102 are loaded in the nests 128 based on signals from the nest sensors 130. The selected one of the loading pins 194 and all of the end effectors 102 that are available and loaded in the nests 128 are displayed to the operator via the user interface 200 on the display 202. Additionally, the display 202 shows the operator whether any of the end effectors 102 isn't loaded or is loaded incorrectly in the nests 128.

In one or more examples, each one of the loading pins 194, each one of the end effectors 102, and each one of the nests 128 are color coded to correspond with each other. This color coding is also displayed by the user interface 200 on the display 202 during the machining operation. For example, the loading pin 194 that corresponds to the workpiece 126, the end effector 102 that corresponds to the workpiece 126, and the nest 128 that corresponds to the end effector 102 each has the same color. The colors displayed by the user interface 200 on the display 202 match the colors of the loading pin 194, the end effector 102, and the nest 128 being used during the machining operation, which provide visual confirmation to the operator.

The operator then inserts the loading pin 194 in the workpiece 126 and loads the workpiece 126 into the tooling fixture 124. The operator uses the tooling fixture 124 to position, index, and lock the workpiece 126 in a correct processing position, for example, using the lift 198, the indexing pins 210, and clamp 196. Once the workpiece 126 is loaded and positioned, the operator checks to ensure the workpiece 126 is correctly positioned.

The operator when initiates the automated machining operation using the user interface 200 and the display 202. In one or more example, the machining system 100 will not allow the operator to start the program if the workpiece 126 is not loaded in the tooling fixture 124 correctly as detected by the tooling sensors 166, if the end effectors 102 are not located in the nests 128 correctly as detected by the nest sensors 130, or if the robotic manipulator 104 is not initialized and ready to commence with the machining operation. In one or more examples, the tooling sensors 166 detect which workpiece 126 is loaded in the tooling fixture 124. The controller 120 automatically selects one of the processing programs 162 that corresponds to the workpiece 126, as detected by the tooling sensors 166 and identified by the controller 120. Therefore, risk of incorrect operator input with respect to selection of the processing program 162 is eliminated.

The robotic manipulator 104 then selects and retrieves one of the end effectors 102 that corresponds to the workpiece 126 loaded in the tooling fixture 124. Having one of the end effectors 102 associated with each type of the workpieces 126 advantageously enables preselection of various process parameters (e.g., physical offsets, tool stroke, other processing parameters 208, etc.) for each type of the workpieces 126 and enables the machining system 100 to be adjusted for the processing parameters of each type of the workpieces 126. Such preselection and adjustment improve efficiency and quality and increase the service life of the machine tool 118.

The robotic manipulator 104 then moves the end effector 102 (i.e., the selected and coupled one of the end effectors 102) over the processing location 142 on the workpiece 126, such as a location of one of the bushings 144 in the workpiece 126. The robotic manipulator 104 holds the end effector 102 over the workpiece surface 178 and directs (e.g., blows) compressed air using the blower 134 while moving the end effector 102 around the processing location 142 to clear away any debris or foreign objects from the processing location 142. This blow off sequence reduces the risk of gouges or other defects in the surface being machined (e.g., the workpiece surface 178 and/or the bushing 144).

The robotic manipulator 104 then positions the end effector 102 directly over the processing location 142 and moves (e.g., lowers) the end effector 102 toward the processing location 142 on the workpiece surface 178. The end-effector sensor 132 detects the workpiece 126 to ensure that the workpiece 126 is still loaded in the tooling fixture 124 in the correct position for processing. Detection of the workpiece 126 using the end-effector sensor 132 ensures that that the operator does not have their hands near the machine tool 118 before it activates and ensures that the end effector 102 is at the processing location 142 on the workpiece 126.

Once a signal is received from the end-effector sensor 132, power 172 is supplied to the machine tool 118 via the automated tool changer 106 and the robotic manipulator 104 begins to apply a machining force (e.g., a downward force) to press the cutting tool 164 on the processing location 142 of the workpiece 126. In one or more examples, the machine tool 118 is mechanically adjusted to an appropriate height relative to the tool housing 160 for the machining operation, for example, by adjusting the location of the machine tool 118 along the processing axis Ap relative to the sleeve 204, thereby, mechanically setting the tool stroke 168. Once the machine tool 118 bottoms out, the robotic manipulator 104 will retract the end effector 102 and then move the end effector 102 to another one of the processing locations 142.

The above-described process is repeated for each remaining one of the processing locations 142 (e.g., additional bushings 144), depending on the type of the workpiece 126.

After all of the processing locations 142 on the workpiece 126 have been machined, the robotic manipulator 104 returns the end effector 102 and places it back in the nest 128 that corresponds to the end effector 102. The robotic manipulator 104 then returns to a home position for initiation of a subsequent machining operation. The operator then removes the workpiece 126 from the tooling fixture 124.

Referring to FIG. 1, the present disclosure is also directed to the controller 120 of the machining system 100. The controller 120 is programmed with the instructions 188 that, when executed by the controller 120, causes the controller 120 to perform operations. In one or more examples, the controller 120 includes a processor 190 programmed with the instructions 188 that, when executed by the processor 190, causes the processor 190 to perform the operations. The operations include the example implementations of the machining method 1000 as described herein and illustrated in FIGS. 1-14. The present disclosure is also directed to a computer program product. The computer program product is an implementation of the instructions 188 and includes a non-transitory computer-readable medium including program code that, when executed by one or more processors (e.g., processor 190), causes the one or more processors to perform operations. The operations include the example implementations of the machining method 1000 as described herein and illustrated in FIGS. 1-14. Generally, the instructions 188 cause the controller 120 to instruct (e.g., command or direct) the robotic manipulator 104 and the machine tool 118 according to the processing program 162.

In one or more examples, the machining system 100 is implemented using software, hardware, firmware, or a combination thereof. When software is used, the operations performed by the machining system 100 are implemented using, for example, without limitation, program code configured to run on a processor unit. When firmware is used, the operations performed by the machining system 100 may be implemented using, for example, without limitation, program code and data and stored in persistent memory to run on a processor unit. When hardware is employed, the hardware may include one or more circuits that operate to perform the operations performed by the machining system 100. Depending on the implementation, the hardware may take the form of a circuit system, an integrated circuit, an application specific integrated circuit (ASIC), a programmable logic device, or some other suitable type of hardware device configured to perform any number of operations. A programmable logic device may be configured to perform certain operations. The device may be permanently configured to perform these operations or may be reconfigurable. A programmable logic device may take the form of, for example, without limitation, a programmable logic array, a programmable array logic, a field programmable logic array, a field programmable gate array, or some other type of programmable hardware device.

In one or more examples, the controller 120 includes or takes the form of a data processing system. In one or more examples, the data processing system includes a communications framework, which provides communications between at least one processor 190 and memory 192 (e.g., one or more storage devices). The processor 190 serves to execute the instructions 188 for software that can be loaded into the memory 192. In one or more examples, the processor 190 is a number of processor units, a multi-processor core, or some other type of processor, depending on the particular implementation. The memory 192 is an example of a storage device or any piece of hardware that is capable of storing information, such as, for example, without limitation, at least one of data, program code in functional form, or other suitable information either on a temporary basis, a permanent basis, or both on a temporary basis and a permanent basis. The memory 192 may also be referred to as computer readable storage devices in one or more examples. The memory 192 is, for example, a random-access memory or any other suitable volatile or non-volatile storage device. Instructions (e.g., instructions 188) for at least one of the operating system, applications, or programs can be located in the memory 192, which is in communication with the processor 190. The processes of the various examples and operations described herein can be performed by the processor 190 using computer-implemented instructions, which can be located in a memory, such as the memory 192. The instructions 188 are also referred to as program code, computer usable program code, or computer readable program code that can be read and executed by a processor of the processor 190. The program code in the different examples can be embodied on different physical or computer readable storage media, such as the memory 192. In one or more examples, the program code is located in a functional form on computer readable media that is selectively removable and can be loaded onto or transferred to the data processing system for execution by the processor 190. In one or more examples, the program code and computer readable media form a computer program product. Additionally, various components of the controller 120 and/or the data processing system may be described as modules. For the purpose of the present disclosure, the term “module” includes hardware, software or a combination of hardware and software. As an example, a module can include one or more circuits configured to perform or execute the described functions or operations of the executed processes described herein (e.g., the machining method 1000). As another example, a module includes a processor, a storage device (e.g., a memory), and computer-readable storage medium having instructions that, when executed by the processor causes the processor to perform or execute the described functions and operations. In one or more examples, a module takes the form of program code and computer readable media, together forming a computer program product.

Referring now to FIGS. 16 and 17, examples of the machining system 100 and the machining method 1000 described herein, may be related to, or used in the context of, an aircraft manufacturing and service method 1100, as shown in the flow diagram of FIG. 16 and the aircraft 1200, as schematically illustrated in FIG. 17. For example, the aircraft 1200 and/or the aircraft production and service method 1100 may include the workpiece 126 that is machined using the machining system 100 and/or according to the machining method 1000.

Referring to FIG. 17, which illustrates an example of the aircraft 1200. The aircraft 1200 includes an airframe 1202 having an interior 1206. The aircraft 1200 includes a plurality of onboard systems 1204 (e.g., high-level systems). Examples of the onboard systems 1204 of the aircraft 1200 include propulsion systems 1208, hydraulic systems 1212, electrical systems 1210, and environmental systems 1214. In other examples, the onboard systems 1204 also includes one or more control systems coupled to an airframe 1202 of the aircraft 1200, such as for example, flaps, spoilers, ailerons, slats, rudders, elevators, and trim tabs. In yet other examples, the onboard systems 1204 also includes one or more other systems, such as, but not limited to, communications systems, avionics systems, software distribution systems, network communications systems, passenger information/entertainment systems, guidance systems, radar systems, weapons systems, and the like. The aircraft 1200 may include various other structures made using the workpiece 126 that is machined using the machining system 100 and/or according to the machining method 1000.

Referring to FIG. 16, during pre-production of the aircraft 1200, the manufacturing and service method 1100 includes specification and design of the aircraft 1200 (block 1102) and material procurement (block 1104). During production of the aircraft 1200, component and subassembly manufacturing (block 1106) and system integration (block 1108) of the aircraft 1200 take place. Thereafter, the aircraft 1200 goes through certification and delivery (block 1110) to be placed in service (block 1112). Routine maintenance and service (block 1114) includes modification, reconfiguration, refurbishment, etc. of one or more systems of the aircraft 1200.

Each of the processes of the manufacturing and service method 1100 illustrated in FIG. 16 may be performed or carried out by a system integrator, a third party, and/or an operator (e.g., a customer). For the purposes of this description, a system integrator may include, without limitation, any number of spacecraft manufacturers and major-system subcontractors; a third party may include, without limitation, any number of vendors, subcontractors, and suppliers; and an operator may be an airline, leasing company, military entity, service organization, and so on.

Examples of the machining system 100 and the machining method 1000 shown and described herein, may be employed during any one or more of the stages of the manufacturing and service method 1100 shown in the flow diagram illustrated by FIG. 16. In an example, machining the workpiece 126 using the machining system 100 and/or according to the machining method 1000 may form a portion of component and subassembly manufacturing (block 1106) and/or system integration (block 1108). Further, workpieces 126 machined using the machining system 100 and/or according to the machining method 1000 may be implemented in a manner similar to components or subassemblies prepared while the aircraft 1200 is in service (block 1112). Also, workpieces 126 machined using the machining system 100 and/or according to the machining method 1000 may be utilized during system integration (block 1108) and certification and delivery (block 1110). Similarly, workpieces 126 machined using the machining system 100 and/or according to the machining method 1000 may be utilized, for example and without limitation, while the aircraft 1200 is in service (block 1112) and during maintenance and service (block 1114).

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

As used herein, the phrase “along an axis” such as in reference to a location or a position along an axis, movement along an axis, and similar phrases, refers to an item being positioned or moving at least approximately parallel to or coincident with the axis.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of”, when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represent a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIGS. 1-10, 12-14 and 17, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 1-10, 12-14 and 17, referred to above, need be included in every example and not all elements, features, and/or components described herein are necessarily depicted in each illustrative example. Accordingly, some of the elements, features, and/or components described and illustrated in FIGS. 1-10, 12-14 and 17 may be combined in various ways without the need to include other features described and illustrated in FIGS. 1-10, 12-14 and 17, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 1-10, 12-14 and 17, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 1-10, 12-14 and 17, and such elements, features, and/or components may not be discussed in detail herein with reference to each of FIGS. 1-10, 12-14 and 17. Similarly, all elements, features, and/or components may not be labeled in each of FIGS. 1-10, 12-14 and 17, but reference numerals associated therewith may be utilized herein for consistency.

In FIGS. 11 and 16, referred to above, the blocks may represent operations, steps, and/or portions thereof and lines connecting the various blocks do not imply any particular order or dependency of the operations or portions thereof. It will be understood that not all dependencies among the various disclosed operations are necessarily represented. FIGS. 11 and 16 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need be performed.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but do not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the machining system 100, the end effector 102, and the machining method 1000 have been shown and described, modifications may occur to those skilled in the art upon reading the specification. The present application includes such modifications and is limited only by the scope of the claims.

What is claimed is:

1. A machining system comprising:
a robotic manipulator;
a master-side automated tool changer coupled to the robotic manipulator;
a master-side data transmission connector coupled to the robotic manipulator;
a plurality of end effectors, each one of the plurality of end effectors comprising:
a machine tool;
a tool-side automated tool changer coupled to the machine tool and coupleable to the master-side automated tool changer; and
a tool-side data transmission connector coupled to the machine tool and coupleable to the master-side data transmission connector; and
a controller in communication with the master-side automated tool changer and the master-side data transmission connector,
wherein, with the master-side automated tool changer coupled to the tool-side automated tool changer of one of the plurality of end effectors:
power is selectively transferred from the master-side automated tool changer to the tool-side automated tool changer;
electrical signals are transferred between the master-side data transmission connector and the tool-side data transmission connector; and
the controller identifies the one of the plurality of end effectors based on one of the electrical signals transferred between the master-side data transmission connector and the tool-side data transmission connector.

2. The machining system of claim 1, further comprising:
a tooling fixture that supports each one of a plurality of workpieces; and
a tooling sensor that identifies each one of the plurality of workpieces supported by the tooling fixture,
wherein:
each one of the plurality of end effectors corresponds to one of the plurality of workpieces; and
the controller selects one of the plurality of end effectors for a corresponding one of the plurality of workpieces.

3. The machining system of claim 1, further comprising:
a plurality of nests, each one of the plurality of nests supports a corresponding one of the plurality of end effectors; and
a plurality of nest sensors, each one of the nest sensors detects that one of the plurality of end effectors is supported by a corresponding one of the plurality of nests.

4. The machining system of claim 1, wherein each one of the end effectors further comprises an end-effector sensor that detects proximity to a workpiece.

5. The machining system of claim 1, wherein:
the master-side data transmission connector comprises a plurality of first contacts;
the tool-side data transmission connector of each one of the plurality of end effectors comprise a plurality of second contacts; and
with the master-side automated tool changer coupled to the tool-side automated tool changer of one of the plurality of end effectors, a select combination of the plurality of second contacts and the plurality of first contacts complete an electrical circuit that corresponds to the one of the plurality of end effectors.

6. The machining system of claim 5, wherein the master-side data transmission connector and the tool-side data transmission connector of each one of the plurality of end effectors comprise a serial communication interface.

7. The machining system of claim 1, wherein the machine tool comprises a pneumatic machine tool.

8. The machining system of claim 1, wherein the machine tool comprises a bushing shaving tool.

9. The machining system of claim 1, wherein:
each one of the plurality of end effectors further comprises a tool housing; and
the machine tool is coupled to and is movable relative to the tool housing along a processing axis.

10. The machining system of claim 9, wherein a tool stroke of the machine tool relative to the tool housing is selectively adjustable.

11. An end effector comprising:
a machine tool;
a tool-side automated tool changer coupled to the machine tool; and
a tool-side data transmission connector coupled to the machine tool,
wherein:
the tool-side automated tool changer is coupleable to a master-side automated tool changer of a robotic manipulator;
the tool-side data transmission connector is coupleable to a master-side data transmission connector of the robotic manipulator; and
with the master-side automated tool changer coupled to the tool-side automated tool changer of the end effector:
power is selectively transferred from the master-side automated tool changer to the tool-side automated tool changer;
electrical signals are transferred between the master-side data transmission connector and the tool-side data transmission connector; and
the end effector is identifiable based on one of the electrical signals transferred between the master-side data transmission connector and the tool-side data transmission connector.

12. The end effector of claim 11, wherein the end effector is selected from a plurality of end effectors and for a corresponding one of a plurality of workpieces.

13. The end effector of claim 11, further comprising an end-effector sensor that detects proximity to a workpiece.

14. The end effector of claim 11, wherein:
the tool-side data transmission connector comprises a plurality of second contacts; and
with the master-side automated tool changer coupled to the tool-side automated tool changer, a select combination of the plurality of second contacts and a plurality of first contacts of the master-side data transmission connector complete an electrical circuit that identifies the end effector.

15. The end effector of claim 11, further comprising a tool housing,
wherein:
the machine tool is coupled to and is movable relative to the tool housing along a processing axis; and
a tool stroke of the machine tool relative to the tool housing is selectively adjustable.

16. A machining method comprising:
detecting each one of a plurality of end effectors;
retrieving a select one of the plurality of end effectors corresponding to a select one of a plurality of workpiece;
identifying the select one of the plurality of end effectors;
moving the select one of the plurality of end effectors over a processing location on the select one of the plurality of workpieces; and
processing the select one of the plurality of workpieces.

17. The method of claim 16, wherein identifying the select one of the plurality of end effectors comprises completed an electrical circuit between a select combination of a plurality of second contacts of a tool-side data transmission connector and a plurality of first contacts of a master-side data transmission connector.

18. The method of claim 16, further comprising:
loading the select one of the plurality of workpieces into a tooling fixture;
detecting a feature of the select one of the plurality of workpieces;
identifying the select one of the plurality of workpieces; and
selecting one of a plurality of processing programs based on identification of the select one of the plurality of workpieces.

19. The method of claim 16, wherein processing the select one of the plurality of workpiece comprises:
engaging a tool housing of the select one of the plurality of end effectors with the select one of the plurality of workpieces;
energizing a machine tool of the select one of the plurality of end effectors; and
moving the machine tool relative to the tool housing along a processing axis.

20. The method of claim 16, further comprising calibrating movement of the select one of the end effectors relative to the processing location on the select one of the plurality of workpieces.
